(19) United States
(12) Patent Application Publication
(10) Pub. No.: US 2002/0105602 A1
(43) Pub. Date: Aug. 8, 2002

(54) Color management system of liquid crystal-display projector

(76) Inventor: Jui-Wen Pan, Taoyan County (TW)

Correspondence Address: BIRCH STEWART KOLASCH & BIRCH, PO BOX 747, FALLS CHURCH, VA, 22040-0747, US

(21) Appl. No.: 09/808,183

(22) Filed: Mar. 15, 2001

(30) Foreign Application Priority Data
Feb. 6, 2001 (TW) 090201821

(51) Int. Cl. G02F 1/1335; G03B 21/14

(52) U.S. Cl. 349/9; 353/20

(57) ABSTRACT

A beam-split system of an LCD projecting apparatus for improving contract effect receives light from the light source of the LCD projecting apparatus and signal of an image to be projected, and outputs images to be projected. The beam-split system includes a plurality of polarizing filters, a plurality of polarization beam splitters (PBS), and three sets of LCD panels. The polarizing filters are for transferring a polarization state of a specific color beam. The PBSs are disposed on the light-path where the polarizing filter located, and each of PBSs includes a pair of prisms for splitting various colors of the polarizing light beam that is incident into the PBS. The LCD panels are to reflect respectively the above-mentioned polarizing light beams having three different colors, and in the meantime, change their polarization state. The characteristic of the beam-split system is as follows: a filter or a coating film capable of filtering a specific color is provided on a peripheral wall of the first set of PBS through which the light path of the beam-split system passes. Another filter or a coating film allowing the specific color to be passed is also provided on another peripheral wall of the same set of PBS. With the filter or the coating film, the probability of having the specific color mixing with other colors in the beam-split system is lowered. Therefore, the purity of various colors in the output light beam is enhanced, and the contrast effect of the output image is improved.

### FIELD OF THE INVENTION

The invention relates to an improvement for a beam-split system of a liquid crystal display (LCD) projecting apparatus, and in particular, relates to a beam-split system having a specific polishing coating film for eliminating the stray light beam in the beam-split system.

### BACKGROUND OF THE INVENTION

Reflective liquid crystal (LCD) display projector is a popular product whose major optical mechanism includes an optical beam-split system. As far as the beam-split system of the reflective LCD projector is concerned, it is composed of the optical devices such as a polarizing light beam splitter (PBS) and a reflective twisted nematic LCD panel etc., and in association with an off-axis or an on-axis light-path design. Among them, although the light-path design for the on-axis is advantageous in the design and manufacturing, it's hard to attain high contrast effect.

FIG. 1 is a cross-sectional view of light-path principle of the beam-split system according to a prior art. The beam-split system includes four sets of PBS and reflective LCD panels with red, blue and green three original colors, and employs the on-axis light-path design. As shown in FIG. 1, the beam-split system 10 includes four sets of PBS 11, 12, 13 & 14, four sets of polarizing filter 15, 16, 17 & 18, a green reflective LCD panel 20, a blue reflective LCD panel 21, a red reflective LCD panel 22, and a polarizer 19. Each of PBS includes two sets of prisms, that is, the PBS 11 includes prisms 111 & 112, the PBS 12 includes prisms 121 & 122, the PBS 13 includes prisms 131 & 132, and the PBS 14 includes prisms 141 & 142.

The light source 1 of the beam-split system 10 generates polarizing light beam 2 in S-polarization state. The polarizing light beam 2 which is reflected by the three LCD panels 20, 21 & 22 receives the signal of an image to be projected, therefore, the beam leaving the beam-split system projects an image, which is represented by the signal, to be projected.

Polarizing filters 15, 16, 17 & 18 being formed by phase retarders can filter a specific color of polarizing light beam. The polarizing filters 15 & 18 can make the red & blue beams passing through them keep in the same polarization state while make the green beam passing through them transform from S-state of polarization to P state. However, the polarizing filters 16 & 17 can make the blue beam passing through them keep in the same polarization state while make the red beam passing through them transform from S-state of polarization to P-state.

As shown in FIG. 1, while the polarization beam reaches the interface of the color-split lens 111 & 112, the red-blue beam (R/B beam) 2a being in s-state is reflected and transmitted toward the polarizing filter 16. And the green beam component 2b being in P-state transmits through prisms 112 and enters into the PBS 12.

The green beam component 2b, after transmitting through the interface of the prisms 121 & 122 and being reflected by the LCD panel 20, transforms from P-state into green-beam 3b in S-state. The green beam 3b, after continuing to transmit through the PBS 14 and being reflected by the interface of the prisms 141 & 142, then transmits through polarizing filter 18. In this way, the green beam 3b can transform from S-state to P-state, and finally pass through the polarizer 19, thereby, form green beam component 4b (G-beam component) of the projecting image.

In the same manner, the polarizing filter 16 can divide the R/B beam 2a into blue beam 21a in S-state and red beam 21b transforming from S-state to P-state. The red beam 21b, after transmitting through the interface of the prisms 131 & 132 and being reflected by the red LCD panel 22, transforms into red beam 2b in S-state. The red beam 2b, after continuing to transmit through the polarizing filter 17, transforms from S-state into P-state, after that, transmits through polarizer 19 and forms a red beam component 23b of projecting image.

In addition, blue-beam 21a, after being reflected respectively by the interface of the prisms 131 & 132 and the blue LCD panel 121, transfers into blue beam 22a in P-state entering into the PBS 14. Subsequently, it keeps on transmitting through the polarizing filter 17, the prisms 141 & 142, the polarizing filter 18 and the polarizer 19, finally becomes a blue beam 23a of projecting image.

Consequently, the three P-state beams of the red, blue and green beam components 23b, 23a & 4b are combined to become the projecting image of the LCD projector.

The above-mentioned beam-split system 10 of the prior art can't generate a projecting image with a perfect contrast effect.

Following are the reasons for why the contrast effect is reduced:

1. The interface of the two prisms of the PBS and the material itself can't reach the ideal condition, thereby, some of P-state polarizing light beams still reflects into the interface of the two prisms. For example, a few of the P-state green beam components 2b will still be reflected together with the S-state R/B beam component 2a.

2. Polarizing filter has a poor polarizing transfer efficiency to transfer the incident polarizing light beam component such that P-state green beam component 2b is mixed up with some of S-state green beam component together reflected by the interface of the prisms 121 & 122. In this way, P-state red beam 21b is also mixed up with S-state red beam component, and all of these will affect the contrast of the final projecting image.

3. Homotropic LCD panel is not easy to manufacture. In general, nematic LCD panel only has perfect polarization effect for the wavelength within a certain range of wavelength. If the incident color beam component transmitting through each of the LCD panels is mixed up with the other color beam components, it will affect the contrast of the final image.

4. Nematic LCD panel can't completely transfer the polarization state of the incident beam, thereby, the stray light will increase to fill in the beam-split system.

Consequently, the beam-split system 10 of the prior art is actually filled with stray-light beam components resulted from various reasons. Most of these beam components in various colors are reflected by each the peripheral walls and the interface between the prisms, and finally transmit through polarizer 19 to become a portion of a projecting image. Therefore, these stray-light beam components affect the contrast effect.

### SUMMARY OF THE INVENTION

An object of the invention is providing a beam-split system of an LCD projecting apparatus having a preferred contract effect, it receives light from the light source of the LCD projecting apparatus and signal of an image to be projected, as well as outputs images to be projected. The beam-split system includes a plurality of polarization filters, a plurality of polarization beam splitters (PBS), and three sets of LCD panels. The polarizing filters are for transforming a polarization state of a specific color beam. The PBS is disposed on the light-path where the polarizing filter located, and each of PBS includes a pair of prisms for splitting the incident colorful polarizing light beam through the PBS. The LCD panels are to reflect respectively the above-mentioned polarizing light beams having three different colors and in the meantime, transform their polarization state.

The characteristics of the beam-split system are as follows: A filter or coating film capable of filtering a specific color of light beam is provided on a peripheral wall of the first set of the PBS being passed by the light path of the beam-split system. Another filter or coating film allowing only the specific color of light beam to be passed is also provided on another peripheral wall of the same set of PBS. Therefore, the specific color of light beam in the beam-split system can be diminished and the probability of having the specific color of light beam mix with the other colors of light beam can be lowered. As a result, the purity of various colors in the output light beam is enhanced, and the contrast effect of the output image is improved.

### BRIEF DSCRIPTION OF TH DRAWING

FIG. 1 is a cross-sectional view of the light-path principle for a beam-split system according to a prior art.

FIG. 2 is a cross-sectional view showing the stray light source of the beam-split system in FIG. 1, and illustrating an improvement method for the beam-split system of the LCD projecting apparatus of an embodiment in accordance with the invention.

### DETAIL DESCRIPTION OF THE PRFERRED EMBODIMENTS

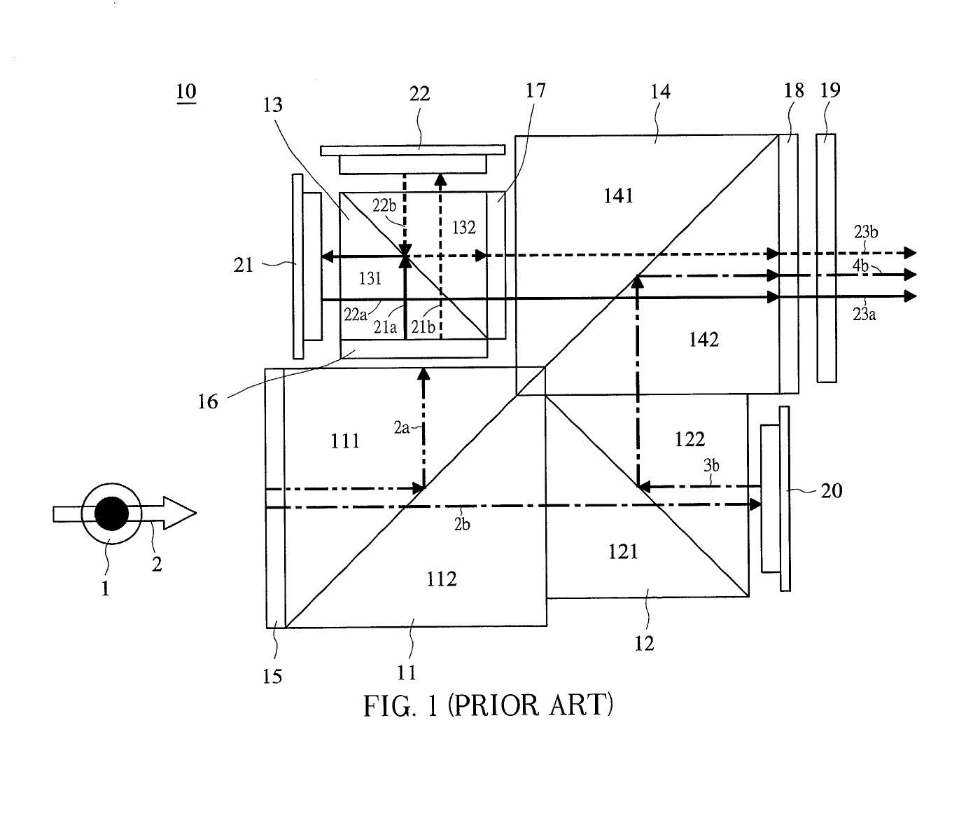

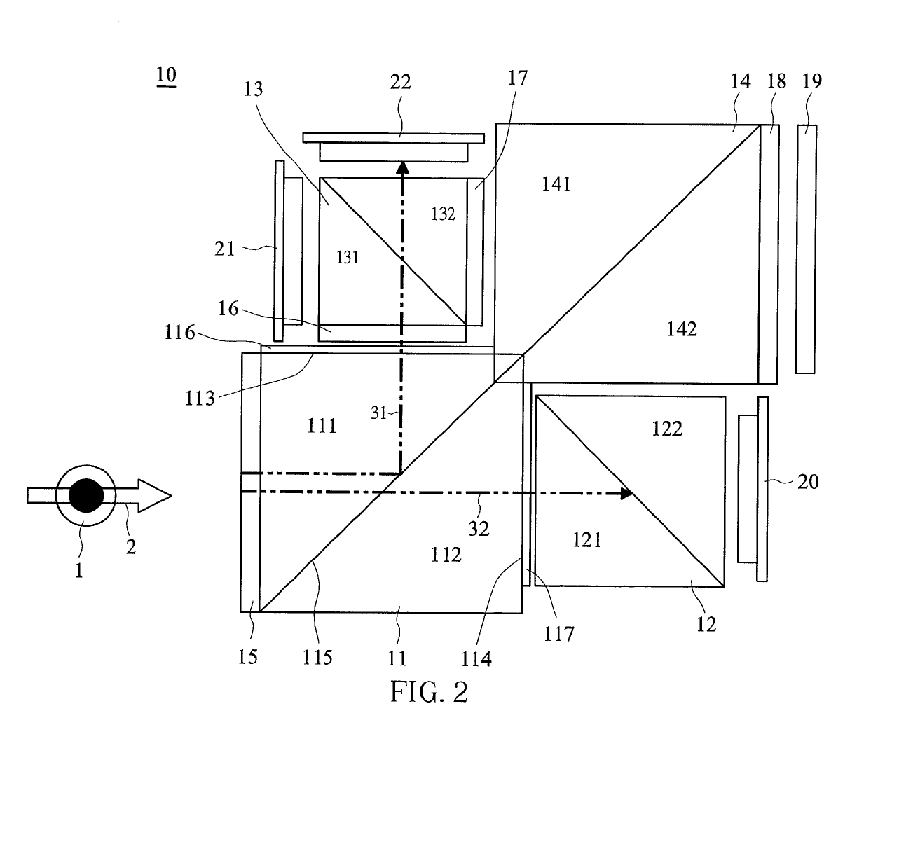

FIG. 2 is a cross-sectional view showing the stray light source of the beam-split system in FIG. 1, and illustrating an improvement method for the beam-split system of the LCD projecting apparatus of an embodiment in accordance with the invention.

As shown in FIG. 2, two kinds of defects, defect due to the conditions of the interface 115 between the two prisms 111 & 112 and defect of the material of the two prisms 111 and 112 themselves, occur in the beam-split system. Due to these defects, portions of the p-state green light beam are subjected to the reflection of the interface 115 and are mixed into the red and blue light beam components 2a to become the so-called green stray light beam 31. This green stray light beam 31 in p-state will continue to pass through the polarizing filter 16, then transmit into the LCD panel 22, and finally become a portion of the output light beam. Besides, a portion of red-and-blue light beams will transmit through the interface 115 to become the so-called red-and-blue stray light beam (R/B stray light beam) 32. This R/B stray light beam in P-state will continue to transmit through the PBS 12, then into the LCD panel 20, and finally to become a portion of the output light beam too. The foregoing stray light beams 31 and 32 will seriously affect the contrast effect of the output image finally obtained in the beam-split system 10

In accordance with the embodiment of the invention, the characteristic of the improved beam-split system 10 are as follows: in the PBS 11, a peripheral wall 113, through which the light beam 2a passes, is coated with coating film 116 that can filter the green light beam. But in the same PBS 11, another peripheral wall 114 through which the light beam 2b passes is provided with a filter 117. This filter 117 can allow only the green light pass, thereby, can filter most of the green stray light 31 and the R/B stray light beam 32. Among them, the green stray light beam 31 is the one transmits through the polarizing filter 16 since the light beam is subjected to the reflection of the interface 115. Also, the R/B stray light beam 32 is the one transmits through the PBS 12 since the light beam transmits through the interface 115. Therefore, the characteristic of the coating film 116 lies in the fact that it can absorb the green light, while the characteristic of the filter 117 lies in the fact that it can transmit the green light through.

What is more, the above-mentioned coating film 116 can be replaced by a filter while the above-mentioned filter 117 can be replaced by a coating film. Thus, the embodiment of the invention is not limited to the use of a filter or a coating film so long as the embodiment possesses the above-mentioned effect.

Generally speaking, as compare with the other portion of the light path, the first set of PBS through which the light path of the beam-split system pass will generate a lot more stray light beams. However, similar to the above-mentioned embodiment, similar disposition can also be employed for other PBSs in the beam-split system, for instance, all the PBS 12, 13, 14 in the foregoing embodiment can dispose appropriate filter or coating film in association with the color of the light beam passing through them.

Therefore, the key point of the invention is to provide filter or coating film in specific color on the periphery wall through which the light path of the PBS passes so as to filter the stray light of the specific color or other colors other than the specific color. In this way, the luminosity of the stray light included in the output light beam of the beam-split system can be diminished, and the contrast effect of the image can be greatly enhanced.

While the invention has been described by way of example and in terms of a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A beam-split system of a liquid crystal display (LCD) projecting apparatus receiving light from the light source of the LCD projecting apparatus and signal of an image to be projected, as well as outputing image to be projected comprising:
a plurality of polarizing filter for transferring a polarization state of a specific color beam;
a plurality of polarizing light beam splitter (PBS) disposed on the light-path where the polarizing filter located, and each PBS includes a pair of prisms for splitting the incident colorful polarizing light beam through the PBS; and
three sets of LCD panels to reflect respectively the above-mentioned polarizing light beams having three different colors and in the meantime, transform their polarization state;
wherein the characteristic of the beam-split system is as follows: a filter or coating film capable of filtering a specific color of light beam is provided on a peripheral wall of the first set of the PBS being passed by the light path of the beam-split system; another filter or coating film allowing only the specific color of light beam to be passed is also provided on another peripheral wall of the same set of PBS.

2. The beam-split system of a LCD projecting apparatus of claim 1, wherein a filter or a coating film of the specific color is a filter or a coating film of one of the red, blue, and green colors.

3. The beam-split system of an LCD projecting apparatus of claim 1, wherein the light beam incident from the light source of the beam-split system is an S-state polarizing light beam.

4. The beam-split system of an LCD projecting apparatus of claim 1, wherein the output light beam of the beam-split system is a P-state polarizing light beam.

5. The beam-split system of an LCD projecting apparatus of claim 1, wherein the beam-split system divides the incident light beam into three basic color light beams, and further makes the three basic color light beams incident to the three sets of LCD panels for forming images.

6. The beam-split system of a LCD projecting apparatus of claim 1, wherein each of the polarizing filters is a combination of phase retarder.

7. The beam-split system of a LCD projecting apparatus of claim 1, wherein the beam-split system is provided with four sets of polarizing filters, among them, two sets of them can transform one of the basic color's polarization state, another two sets can transform another one of the three basic color's polarization state.

8. The beam-split system of an LCD projecting apparatus of claim 1, wherein the beam-split system further comprises four sets of polarization beam splitter.

9. The beam-split system of an LCD projecting apparatus of claim 1, wherein the LCD panel is a reflective twisted nematic LCD panel.

10. The beam-split system of an LCD projecting apparatus of claim 1, wherein a light beam polarizer is further provided at the end of the light path to enhance the contract effect of the projected images generated by the beam-split system.
